(19) United States
(12) Patent Application Publication
(10) Pub. No.: US 2026/0142350 A1
(43) Pub. Date: May 21, 2026

(54) SECONDARY BATTERY AND METHOD OF MANUFACTURING SECONDARY BATTERY

(71) Applicant: SAMSUNG SDI CO., LTD., Yongin-si (KR)

(72) Inventors: Eunjeong MOON, Yongin-si (KR); Seokyo JEOUNG, Yongin-si (KR); Donghyun KIM, Yongin-si (KR); Yejin SEO, Yongin-si (KR)

(21) Appl. No.: 19/214,216

(22) Filed: May 21, 2025

(30) Foreign Application Priority Data
Nov. 21, 2024 (KR) 10-2024-0167401

(51) Int. Cl. H01M 50/538; H01M 10/0587; H01M 50/105; H01M 50/148; H01M 50/186; H01M 50/533; H01M 50/536

(52) U.S. Cl. CPC H01M 50/538; H01M 10/0587; H01M 50/105; H01M 50/148; H01M 50/186; H01M 50/533; H01M 50/536

(57) ABSTRACT

A secondary battery includes an electrode assembly including a first electrode including a plurality of first substrate tabs extending in a first direction, a second electrode including a plurality of second substrate tabs extending in the first direction, and a separator disposed between the first and second electrodes. A case in which the electrode assembly is accommodated. A cover seals at least a portion of the electrode assembly from outside of the case and the cover. The first substrate tabs are coupled to each other to form a first multi-tab, with a portion of the first multi-tab exposed to outside of the case and the cover. The second substrate tabs are coupled to each other to form a second multi-tab, with a portion of the second multi-tab exposed to outside of the case and the cover.

### CROSS-REFERENCE TO RELATED APPLICATION

This application claims priority under 35 U.S. C § 119 to Korean Patent Application No. 10-2024-0167401, filed in the Korean Intellectual Property Office on Nov. 21, 2024, the entire contents of which are hereby incorporated by reference.

### BACKGROUND

### Technical Field

The present disclosure relates to a secondary battery and a method for manufacturing a secondary battery.

Unlike primary batteries that are not designed to be (re)charged, secondary (or rechargeable) batteries are batteries that are designed to be discharged and recharged. Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and for storing power (e.g., home and/or utility scale power storage). A secondary battery generally includes an electrode assembly composed of a positive electrode and a negative electrode, a case accommodating the same, and electrode terminals connected to the electrode assembly.

To reduce the weight of secondary batteries used in portable IT devices and automobiles, there has been research on small and thin batteries. Conventionally, in order to miniaturize and reduce the thickness of a secondary battery, methods have been devised such as reducing the thickness of materials applied to the secondary battery (e.g., substrate, separator, exterior material), or improving the physical properties of an active material to increase energy density. However, such methods may result in a secondary battery that is less safe.

There is also a continued desire to reduce dead space inside of a secondary battery. For example, methods have been developed to increase energy density by minimizing portions of the internal battery space that do not contribute to battery capacity.

The above information disclosed in this Background section is for enhancement of understanding of the background of the present disclosure, and therefore, it may contain information that does not constitute related (or prior) art.

### SUMMARY

The present disclosure provides a secondary battery and a method of manufacturing a secondary battery to solve the above-described technical problems.

However, the technical problem to be solved by the present disclosure is not limited to the above problems, and other problems not mentioned herein, and aspects and features of the present disclosure that would address such problems, will be clearly understood by those skilled in the art from the description of the present disclosure below.

Aspects of the present disclosure provide a secondary battery including an electrode assembly including a first electrode including a plurality of first substrate tabs extending in a first direction, a second electrode spaced apart from the first electrode in a second direction perpendicular that is to the first direction and including a plurality of second substrate tabs extending in the first direction, and a separator disposed between the first electrode and the second electrode, a case in which the electrode assembly is accommodated, and a cover coupled to the case and sealing a portion of the electrode assembly from outside of the case and the cover, wherein the first substrate tabs are coupled to each other to form a first multi-tab, a portion of the first multi-tab is exposed outside of the case of the cover, and the second substrate tabs are coupled to each other to form a second multi-tab, and a portion of the second multi-tab is exposed outside of the case and the cover.

In some embodiments, the secondary battery may further include a first sealing member attached to surfaces of the first multi-tab, and a second sealing member attached to surfaces of the second multi-tab.

In some embodiments, the first sealing member may be in contact with the case and the cover, the case and the cover are sealed with the first sealing member interposed between the case and the cover, and the first sealing member insulates the first multi-tab from the case and the cover.

In some embodiments, a portion of the first sealing member extends in the first direction may be exposed outside of the case and the cover in the first direction.

In some embodiments, the first multi-tab may be formed by ultrasonically welding the first substrate tabs together, and the second multi-tab is formed by ultrasonically welding the second substrate tabs together.

In some embodiments, the first multi-tab may be formed by welding the first substrate tabs from first ends of the first substrate tabs in the second direction to second ends of the first substrate tabs in the second direction.

In some embodiments, the first multi-tab may be formed by welding the first substrate tabs in a section that is closer to an end of the first substrate tabs in the first direction than to the separator.

In some embodiments, the portion of the first multi-tab that may be exposed to outside of the case is formed by welding along a surface of the first multi-tab from a first end of the first multi-tab to a second end of the first multi-tab.

In some embodiments, among the first substrate tabs, one of the substrate tabs may be not bent and may extend in the first direction.

Aspects of embodiments provide a method of manufacturing a secondary battery including forming an electrode assembly including (i) a first electrode including a plurality of first substrate tabs extending in a first direction, (ii) a second electrode disposed spaced apart from the first electrode in a second direction that is perpendicular to the first direction and including a plurality of second substrate tabs extending in the first direction, and (iii) a separator disposed between the first electrode and the second electrode, forming a first multi-tab by coupling the first substrate tabs, forming a second multi-tab by coupling the second substrate tabs, inserting the electrode assembly into the case including an opening such that a portion of the first multi-tab and a portion of the second multi-tab are exposed outside of the case, and covering the opening in the case with a cover to seal a portion of the electrode assembly from outside of the case and cover.

In some embodiments, forming the first multi-tab may include cutting a portion of the first multi-tab, and attaching a sealing member to surfaces of the cut first multi-tab.

In some embodiments, forming the first multi-tab may include attaching a sealing member to surfaces of the first multi-tab, and after attaching the sealing member, cutting off a portion of the first multi-tab.

In some embodiments, covering the opening in the case with the cover to seal may include attaching the sealing member to surfaces of the first multi-tab such that the sealing member contacts the case and the cover.

In some embodiments, the case and the cover may be sealed with the sealing member interposed therebetween, and the sealing member insulates the first multi-tab from the case and the cover.

In some embodiments, a portion of the sealing member may be exposed outside of the case and the cover in the first direction.

In some embodiments, forming the first multi-tab may include ultrasonically welding the first substrate tabs, and forming the second multi-tab may include ultrasonically welding the second substrate tabs.

In some embodiments, forming the first multi-tab may include welding the first substrate tabs from first ends of the first substrate tabs in the second direction to second ends of the first substrate tabs in the second direction.

In some embodiments, forming the first multi-tab may include welding the first substrate tabs in the first direction in a section that is closer to an end of the first substrate tabs in the first direction than to the separator.

In some embodiments, the portion of the first multi-tab that is exposed e outside of the case may be formed by welding a surface of the first multi-tab from a first end of the first multi-tab to a second end of the first multi-tab.

In some embodiments, among the plurality of first substrate tabs, a substrate tab may be not bent and extend in the first direction.

According to embodiments of the present disclosure, in battery employing multilayer substrate tabs, a multi-tab formed by coupling substrate tabs may replace electrode leads, thereby simplifying the welding process and reducing the number of components.

According to embodiments of the present disclosure, the space required to bend electrode leads within the case may be eliminated, thus removing the need for additional bending sections. After the electrode assembly is inserted into the case, the space occupied by substrate tabs in the longitudinal direction of the electrode assembly may be minimized. As a result, the energy density of the secondary battery may be improved. Additionally, the time and cost associated with the bending process may be reduced.

According to embodiments of the present disclosure, the welding area between components in the secondary battery may be reduced, thereby lowering the resistance generation within the secondary battery. Thus, output characteristics of the secondary battery may be improved and heat generation may be suppressed.

According to embodiments of the present disclosure, a multi-tab formed by coupling substrate tabs may replace electrode leads. As a result, during the battery-pack manufacturing process in which a PCM (Protection Circuit Module) is mounted on the secondary battery, the PCM connected to the secondary battery may be simply bent through a streamlined process and positioned accurately at the upper portion of the secondary battery.

However, aspects and features of the present disclosure are not limited to those described above, and other aspects and features not mentioned will be clearly understood by a person skilled in the art from the detailed description, described below.

### BRIEF DESCRIPTION OF THE DRAWINGS

The following drawings attached to this specification illustrate embodiments of the present disclosure, and further describe aspects and features of the present disclosure together with the detailed description of the present disclosure. Thus, the present disclosure should not be construed as being limited to the drawings.

FIG. 1 is an exploded perspective view of a secondary battery according to an embodiment of the present disclosure.

FIG. 2 is a front view of a secondary battery according to an embodiment of the present disclosure.

FIG. 3 is an enlarged view of area A of FIG. 2.

FIG. 4 is a cross-sectional view taken along line B-B′ of FIG. 2.

FIG. 5 is a view of an electrode assembly that includes a plurality of first substrate tabs.

FIG. 6 is a view of the plurality of first substrate tabs of FIG. 5.

FIG. 7 is a view of a first substrate tab before welding.

FIG. 8 is a view of the multi-tab formed after the plurality of first substrate tabs of FIG. 7 are welded and a cutting line.

FIG. 9 is a view of the multi-tab in a cut state along the cutting line of FIG. 8.

FIG. 10 is a perspective view of the multi-tab of FIG. 9.

FIG. 11 is a view of a first sealing member attached to the cut multi-tab of FIG. 9.

FIG. 12 is a cross-sectional view of the first sealing member attached to the multi-tab of FIG. 11.

FIG. 13 is a view of a multi-tab formed according to another embodiment of the present disclosure.

FIG. 14 is a view of the multi-tab of FIG. 13 cut along a cutting line.

FIG. 15 is a view of a protection circuit module attached to a secondary battery according to an embodiment of the present disclosure.

FIG. 16 is a view of the protection circuit module of FIG. 15 bent 90 degrees rearward.

FIG. 17 is a view of the protection circuit module of FIG. 16 bent 180 degrees forward.

FIG. 18 is a flowchart of a method of manufacturing a secondary battery according to an embodiment of the present disclosure.

### DETAILED DESCRIPTION

Hereinafter, embodiments of the present disclosure will be described, in detail, with reference to the accompanying drawings. The terms or words used in the present specification and claims are not to be limitedly interpreted as general or dictionary meanings and should be interpreted as meanings and concepts that are consistent with the technical idea of the present disclosure on the basis of the principle that an inventor can be his/her own lexicographer to appropriately define concepts of terms to describe his/her invention in the best way.

The embodiments described in this specification and the configurations shown in the drawings are only some of the embodiments of the present disclosure and do not represent all of the technical spirit, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, etc. as being “the same” may mean that they are “substantially the same.” Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed” between the components”.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

In this specification, a singular expression includes a plural expression unless it is specifically stated as singular in the context, and a plural expression includes the singular expression unless it is specifically stated as plural in the context. Throughout the specification, when a portion is referred to as including a certain component, it means that the portion may include other components as well, unless there is particular disclosure to the contrary.

In the present disclosure, the size and relative size of layers and regions shown in the drawings may be exaggerated for clarity of description. That is, the sizes shown in the drawings are merely for convenience and the present disclosure is not limited thereto. The same reference numerals throughout the specification refer to the same components.

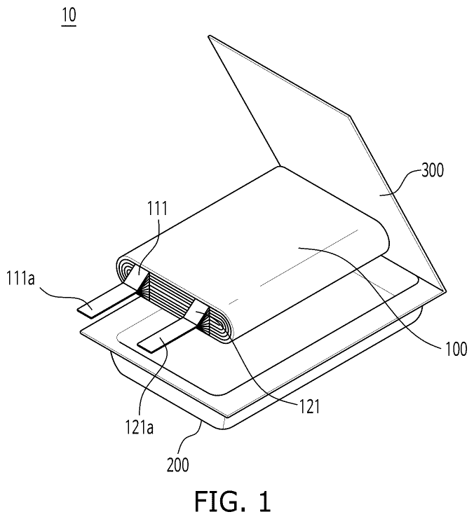

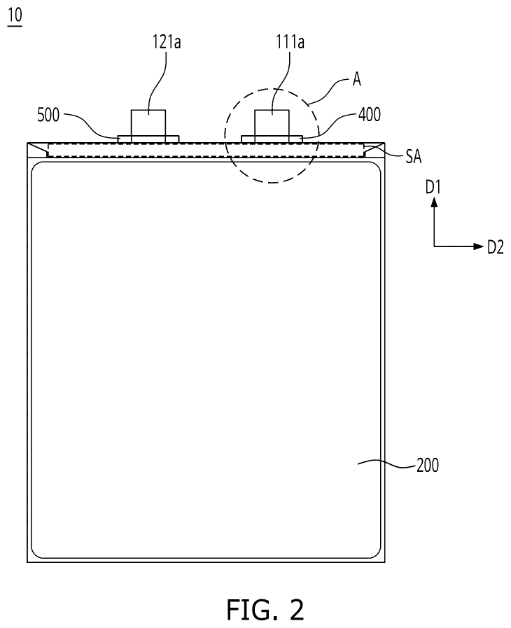

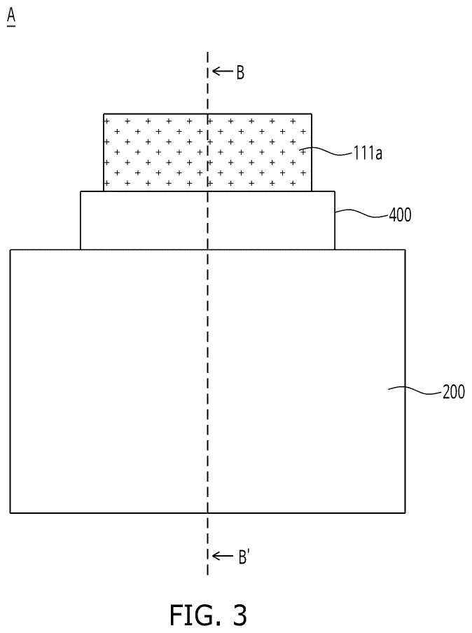

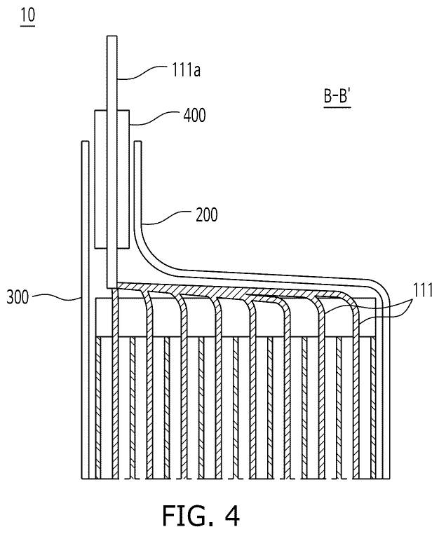

FIG. 1 is an exploded perspective view of a secondary battery according to an embodiment of the present disclosure, FIG. 2 is a front view of a secondary battery according to an embodiment of the present disclosure, FIG. 3 is an enlarged view of area A of FIG. 2, and FIG. 4 is a cross-sectional view taken along line B-B′ of FIG. 2.

Referring to FIGS. 1 through 4, the secondary battery 10 according to the present disclosure may include an electrode assembly 100, a case 200 having an open space (e.g., one open surface) to accommodate the electrode assembly 100, and a cover 300 configured to cover the open space of the case 200 so as to seal or seal off at least a portion of the electrode assembly 100 from outside of the secondary battery. The electrode assembly 100 may include a first electrode, a second electrode, and a separator disposed between the first electrode and the second electrode.

In an embodiment, the first electrode and the second electrode may be wound with a separator, which is an insulator, interposed between the first electrode and the second electrode. However, the present disclosure is not limited to such a configuration, and the electrode assembly 100 may have a structure in which a plurality of sheets of first electrodes and second electrodes are alternately stacked with separator(s) interposed between the first and second electrodes.

The first electrode may include a plurality of first substrate tabs 111 that extend in the first direction D1. The first substrate tabs 111 may be electrically connected to a first uncoated portion of the first electrode, with the first uncoated portion being formed on one side of the first electrode. Each of the plurality of first substrate tabs 111 may protrude to a specific position of the electrode assembly 100, and the plurality of first substrate tabs 111 may be coupled together to form a first multi-tab 111a.

The second electrode may include a plurality of second substrate tabs 121 that are spaced apart from the first electrode in a second direction D2 that is perpendicular to the first direction D1. The second substrate tabs 121 may extend in the first direction D1. The plurality of second substrate tabs 121 may be electrically connected to a second uncoated portion of the second electrode, with the second uncoated portion being formed on one side of the second electrode. Each of the plurality of second substrate tabs 121 may protrude to a specific position of the electrode assembly 100, and the plurality of second substrate tabs 121 may be coupled together to form a second multi-tab 121a.

The plurality of first substrate tabs 111 and the plurality of second substrate tabs 121 may be spaced apart from each other and protrude from the same surface of the electrode assembly 100. In other embodiments, the specific position from which the plurality of first substrate tabs 111 protrude from the electrode assembly 100 may differ from the specific position from which the plurality of second substrate tabs 121 protrude from the electrode assembly 100. For example, the plurality of first substrate tabs 111 may protrude from a first surface of the electrode assembly 100, and the plurality of second substrate tabs 121 may protrude from a second surface of the electrode assembly 100.

The plurality of first substrate tabs 111 may be coupled together to form a first multi-tab that is partially exposed outside of the case 200. The plurality of second substrate tabs 121 may be coupled together to form a second multi-tab 121a that is partially exposed outside the case 200.

In an embodiment, the first multi-tab 111a may be formed by ultrasonically welding the first substrate tabs 111, and the second multi-tab 121a may be formed by ultrasonically welding the second substrate tabs 121. In another example, the first multi-tab 111a may be formed by laser-welding the first substrate tabs 111, and the second multi-tab 121a may be formed by laser-welding the second substrate tabs 121.

When ultrasonically welding the first substrate tabs 111, an oxide film of the metal surface of each first substrate tab 111 may be destroyed by the welding, and the first substrate tabs 111 may be mutually bonded at their interfaces. Accordingly, the first substrate tabs 111 may be integrated to form the first multi-tab 111a. In this case, a portion of the first multi-tab 111a that is exposed outside of the case 200 may be welded along a surface of the first multi-tab from a first end of the first multi-tab to a second end of the first multi-tab. Thus, even if an external terminal or the like is coupled, sufficient strength may be maintained.

Similarly, when ultrasonically welding the plurality of second substrate tabs 121, an oxide film of the metal surface of each second substrate tab 121 may be destroyed by the welding, and the plurality of second substrate tabs 121 may be mutually bonded at their interfaces. Accordingly, the plurality of second substrate tabs 121 may be integrated to form the second multi-tab 121a.

As a comparative example, in a multi-layer substrate tab configuration (Multi Tab Winding, Stack), the substrate tab may be welded to an electrode lead so that the electrode lead protrudes to outside the secondary battery case. In such an arrangement, a first welding is carried out to connect the substrate tabs so that the substrate tabs do not fold or spread apart. Then a second welding is carried out to couple the substrate tabs to the electrode lead. As a result, welding sections are needed for both coupling the substrate tabs to the electrode lead and also coupling the electrode lead to an external bus bar. The multiple welding sections increase resistance in the secondary battery. Increased welding sections and increased resistance may lead to decreased output performance of the secondary battery and an increased heat generation.

In contrast, according to embodiments of the present disclosure, the first multi-tab 111a formed by coupling the plurality of first substrate tabs 111 and the second multi-tab 121a formed by coupling the plurality of second substrate tabs 121 may function in the same manner as a conventional electrode lead, which thereby allows for a reduces the number of welding sections. Further, in some conventional examples where an electrode lead is used, the electrode tab and/or substrate tabs must be bent inside the case. But in embodiments of the present disclosure, such a bending is not necessary, and eliminating bending simplifies the manufacturing process. Furthermore, by removing the electrode lead, a welding tape that would normally be attached to the electrode lead is not needed, which thereby simplifies the battery structure.

The case 200 forms exterior of the secondary battery 10 and provides a space to house the electrode assembly 100. The case 200 may have an opening on one side through which the electrode assembly 100 is inserted into the accommodating space inside of the case 200. An electrolyte may be injected inside the case 200, and the opening of the case 200 may be sealed by the cover 300. The case 200 may be formed from a conductive metal such as aluminum, aluminum alloy, or nickel-plated steel, a laminate film, or plastic material.

In FIG. 1, the case 200 is a pouch-type case, and the secondary battery 10 is a pouch-type secondary battery. However, the present disclosure is not limited to these types of cases and batteries. The secondary battery 10 may be other types, such as prismatic or cylindrical battery.

The secondary battery 10 may be a lithium secondary battery, a sodium secondary battery, etc. The scope of the present disclosure is not limited in this regard and includes any rechargeable battery that may repeatedly provide electricity through charging and discharging.

The configuration of the secondary battery 10 shown in FIG. 1 is merely an example. Some embodiments may include additional components beyond what is shown, and in other embodiment some components may be omitted. Further, the shapes and positional relationships of each component of the secondary battery 10 shown in FIG. 1 may be altered as appropriate.

The secondary battery 10 may further include a first sealing member 400 attached to surfaces of the first multi-tab 111a, and a second sealing member 500 attached to surfaces of the second multi-tab 121a.

The first sealing member 400 may be attached to surfaces of the first multi-tab 111a and be in contact with the case 200 and the cover 300. The first sealing member 400 may insulate the first multi-tab 111a from the case 200 and the cover 300. The first sealing member 400 may be a thin film or plate shape.

The case 200 and the cover 300 may be sealed with the first sealing member 400 interposed therebetween. And the case 200 and the cover 300 may be sealed with the second sealing member 500 interposed therebetween. For example, as shown in FIG. 2, the first multi-tab 111a may be disposed between the case 200 and the cover 300 with the first sealing member 400 attached to surfaces of the first multi-tab 111a, and the second multi-tab 121a may be disposed between the case 200 and the cover 300 with the second sealing member 500 attached to surfaces of the second multi-tab 121a. With the first sealing member 400 and the second sealing member 500 interposed between the case 200 and the cover 300, the case 200 and the cover 300 may be sealed by applying pressure with a heating jig. For example, as shown, the case 200 and the cover 300 may be sealed at the sealing area SA using a heating jig.

The first sealing member 400 may be formed of an insulating material containing polyimide or polypropylene. The first sealing member 400 may insulate the portion of the first multi-tab 111a that is in contact with the case 200 and the cover 300.

The first sealing member 400 may be partially exposed to the outside of the case 200 and the cover 300 in the first direction D1. That is, with cover 300 coupled to the case 200, a portion of the overall length of the first sealing member 400 may be exposed to outside of the case 200 and cover 300 in the first direction D1. The length of the first sealing member 400 may be defined as the first sealing member 400 extending in the first direction D1. In an example, about 20% to about 40% of the length of the first sealing member 400 in the first direction may be exposed to outside of the case 200 and the cover 300.

Likewise, the second sealing member 500 may be attached to surfaces of the second multi-tab 121a and in contact with the case 200 and the cover 300. The second sealing member 500 may insulate the second multi-tab 121a from the case 200 and the cover 300, and the second sealing member 500 may have a thin film or plate shape.

The second sealing member 500 may be formed of an insulating material containing polyimide or polypropylene. The second sealing member 500 may insulate the portion of the second multi-tab 121a in contact with the case 200 and the cover 300.

The second sealing member 500 may be partially exposed to outside of the case 200 and the cover 300 in the first direction D1. That is, when the cover 300 is coupled to the case 200, a portion of the overall length of the second sealing member 500 may be exposed in the first direction D1. The length of the second sealing member 500 may be defined as the second sealing member 500 extending in the first direction D1. In an example, about 20% to about 40% of the length of second sealing member 500 in the first direction D1 is exposed to outside of the case 200 and the cover 300.

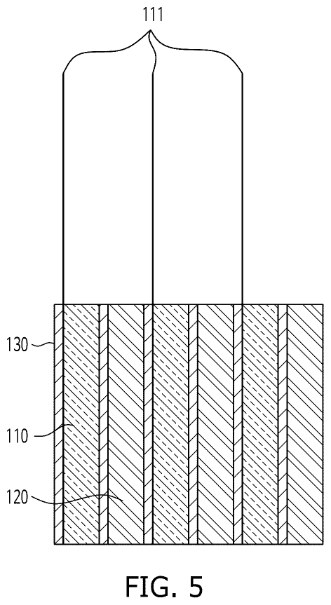

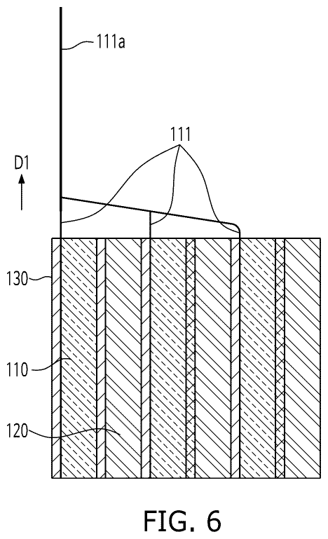

FIG. 5 is a view of an electrode assembly that includes a plurality of first substrate tabs, and FIG. 6 is a view of the plurality of first substrate tabs of FIG. 5 integrated by ultrasonic welding.

Referring to FIGS. 5 and 6, among the plurality of first substrate tabs 111, a specific first substrate tab 111 may not be bent (or may be in an unbent state) and may extend in the first direction D1. For example, as shown in FIG. 6, the specific first substrate tab 111 extending in the first direction D1, and the other first substrate tabs 111 are bent in the thickness direction of the electrode assembly so as to be coupled to the specific first substrate tab 111. Accordingly, the first multi-tab 111a may be formed with the specific first substrate tab 111 that is not bent and the other first substrate tabs 111 that are bent. As compared to the addition of a conventional electrode lead, a separate bending process is not required, and only a space corresponding to the length in the first direction D1 of the bent portion of the plurality of first substrate tabs 111 is needed for the electrode assembly in the case. Thus, the energy density of the secondary battery may be improved.

The electrode assembly may include a plurality of first electrodes 110, a plurality of second electrodes 120, and a separator 130 disposed between each adjacent first electrode 110 and second electrode 120.

In an embodiment, the first electrode 110 may include a plurality of first substrate tabs 111 disposed on one surface of the first electrode 110 and extending in the first direction D1. The first substrate tabs 111 may protrude toward the upper side of the electrode assembly 100. At least some of the first substrate tabs 111 may be coupled to form the first multi-tab 111a. In particular, at least some of the plurality of first substrate tabs 111 may be welded together to form the first multi-tab 111a. Ultrasonic or laser welding may be used to couple the first substrate tabs 111 to form the first multi-tab 111a. The first multi-tab 111a may refer to a single electrode tab formed by welding the plurality of first substrate tabs 111. By welding the first substrate tabs 111 to form the first multi-tab 111a, adhesion between the first substrate tabs 111 may be improved.

Referring to FIG. 6, the first substrate tabs 111 may overlap in the thickness direction of the electrode assembly 100 to form the first multi-tab 111a. The thickness direction of the electrode assembly 100 may intersect the first direction D1 at a right angle.

The first electrode 110 may include a first substrate and a first active material layer disposed on the first substrate. The first substrate tab 111 may extend outward from a first uncoated portion of the first substrate where the first active material layer is not provided. The second electrode 120 may include a second substrate and a second active material layer disposed on the second substrate. The second substrate tab may extend outward from a second uncoated portion of the second substrate where the second active material layer is not provided.

The first electrode 110 may function as a positive electrode. In such a case, the first substrate may be a positive electrode substrate. The positive electrode substrate may be composed of aluminum foil, and the positive electrode active material may include, for example, a transition metal oxide.

The positive electrode active material may include a compound (lithiated intercalation compound) that is capable of intercalating and deintercalating lithium. Specifically, at least one of a composite oxide of lithium and a metal selected from cobalt, manganese, nickel, and combinations thereof may be used.

The composite oxide may be a lithium transition metal composite oxide. Specific examples of the composite oxide may include lithium nickel-based oxide, lithium cobalt-based oxide, lithium manganese-based oxide, lithium iron phosphate-based compound, cobalt-free nickel-manganese-based oxide, or a combination thereof.

As an example, the following compounds represented by any one of the following Chemical Formulas may be used. LiaA1-bXbO2-cDc (0.90≤a≤1.8, 0≤b≤0.5, and 0≤c≤0.05); LiaMn2-bXbO4-cDc (0.90≤a≤1.8, 0≤b≤0.5, and 0≤c≤0.05); LiaNi1-b-cCobXcO2-αDα (0.90≤a≤1.8, 0≤b≤0.5, 0≤c≤0.5, and 0<α<2); LiaNi1-b-cMnbXcO2-αDα (0.90≤a≤1.8, 0≤b≤0.5, 0≤c≤0.5, and 0<α<2); LiaNibCocL1dGeO2 (0.90≤a≤1.8, 0≤b≤0.9, 0≤c≤0.5, 0≤d≤0.5, and 0≤e≤0.1); LiaNiGbO2 (0.90 ≤a≤1.8 and 0.001≤b≤0.1); LiaCoGbO2 (0.90≤a≤1.8 and 0.001≤b≤0.1); LiaMn1-bGbO2 (0.90≤a≤1.8 and 0.001≤b≤0.1); LiaMn2GbO4 (0.90 ≤a≤1.8 and 0.001≤b≤0.1); LiaMn1-gGgPO4 (0.90≤a≤1.8 and 0≤g≤0.5); Li(3-f)Fe2(PO4)3 (0≤f≤2); or LiaFePO4 (0.90≤a≤1.8).

In the above Chemical Formulas, A is Ni, Co, Mn, or a combination thereof; X is Al, Ni, Co, Mn, Cr, Fe, Mg, Sr, V, a rare earth element or a combination thereof; D is O, F, S, P, or a combination thereof; G is Al, Cr, Mn, Fe, Mg, La, Ce, Sr, V, or a combination thereof; and L1 is Mn, Al, or a combination thereof.

The positive electrode active material may be, for example, a high nickel-based positive electrode active material having a nickel content of greater than or equal to about 80 mol %, greater than or equal to about 85 mol %, greater than or equal to about 90 mol %, greater than or equal to about 91 mol %, or greater than or equal to about 94 mol % and less than or equal to about 99 mol % based on 100 mol % of the metal excluding lithium in the lithium transition metal composite oxide. The high-nickel-based positive electrode active material may be capable of realizing high capacity and can be applied to a high-capacity, high-density rechargeable lithium battery.

The second electrode 120 may function as a negative electrode. In such a case, the second substrate may be a negative electrode substrate. The negative electrode substrate may be, for example, copper foil or nickel foil, and the negative electrode active material may include, for example, graphite. The negative electrode active material may include a material that reversibly intercalates/deintercalates lithium ions, a lithium metal, a lithium metal alloy, a material capable of doping/dedoping lithium, or a transition metal oxide.

The material that reversibly intercalates/deintercalates lithium ions may include a carbon-based negative electrode active material, such as, for example. crystalline carbon, amorphous carbon or a combination thereof. The crystalline carbon may be graphite such as non-shaped, sheet-shaped, flake-shaped, sphere-shaped, or fiber-shaped natural graphite or artificial graphite. The amorphous carbon may be a soft carbon, a hard carbon, a mesophase pitch carbonization product, calcined coke, and the like.

The lithium metal alloy includes an alloy of lithium and a metal selected from Na, K, Rb, Cs, Fr, Be, Mg, Ca, Sr, Si, Sb, Pb, In, Zn, Ba, Ra, Ge, Al, and Sn.

The material capable of doping/dedoping lithium may be a Si-based negative electrode active material or a Sn-based negative electrode active material. The Si-based negative electrode active material may include silicon, a silicon-carbon composite, SiOx (0<x<2), a Si-Q alloy (where Q is selected from an alkali metal, an alkaline-earth metal, a Group 13 element, a Group 14 element (excluding Si), a Group 15 element, a Group 16 element, a transition metal, a rare earth element, and a combination thereof). The Sn-based negative electrode active material may include Sn, SnO2, a Sn-based alloy, or a combination thereof.

The silicon-carbon composite may be a composite of silicon and amorphous carbon. According to an embodiment, the silicon-carbon composite may be in a form of silicon particles and amorphous carbon coated on the surface of the silicon particles. For example, the silicon-carbon composite may include a secondary particle (core) in which primary silicon particles are assembled, and an amorphous carbon coating layer (shell) on the surface of the secondary particle. The amorphous carbon may also be between the primary silicon particles, and, for example, the primary silicon particles may be coated with the amorphous carbon. The secondary particle may exist dispersed in an amorphous carbon matrix.

The silicon-carbon composite may further include crystalline carbon. For example, the silicon-carbon composite may include a core including crystalline carbon and silicon particles and an amorphous carbon coating layer on a surface of the core.

The Si-based negative electrode active material or the Sn-based negative electrode active material may be used in combination with a carbon-based negative electrode active material.

The separator 130 may include polyethylene, polypropylene, polyvinylidene fluoride, or a multilayer film of two or more layers thereof, and a mixed multilayer film such as a polyethylene/polypropylene two-layer separator, polyethylene/polypropylene/polyethylene three-layer separator, polypropylene/polyethylene/polypropylene three-layer separator, and the like.

The separator may include a porous substrate and a coating layer including an organic material, an inorganic material, or a combination thereof on one or both surfaces of the porous substrate.

The porous substrate may be a polymer film formed of any one selected polymer polyolefin such as polyethylene and polypropylene, polyester such as polyethylene terephthalate and polybutylene terephthalate, polyacetal, polyamide, polyimide, polycarbonate, polyether ketone, polyarylether ketone, polyether ketone, polyetherimide, polyamideimide, polybenzimidazole, polyethersulfone, polyphenylene oxide, a cyclic olefin copolymer, polyphenylene sulfide, polyethylene naphthalate, a glass fiber, TEFLON®, and polytetrafluoroethylene, or a copolymer or mixture of two or more thereof.

The organic material may include a polyvinylidene fluoride-based polymer or a (meth)acrylic polymer.

The inorganic material may include inorganic particles selected from Al2O3, SiO2, TiO2, SnO2, CeO2, MgO, NiO, CaO, GaO, ZnO, ZrO2, Y2O3, SrTiO3, BaTiO3, Mg(OH)2, boehmite, and a combination thereof, but is not limited thereto.

The organic material and the inorganic material may be mixed in one coating layer, or a coating layer including an organic material and a coating layer including an inorganic material may be stacked.

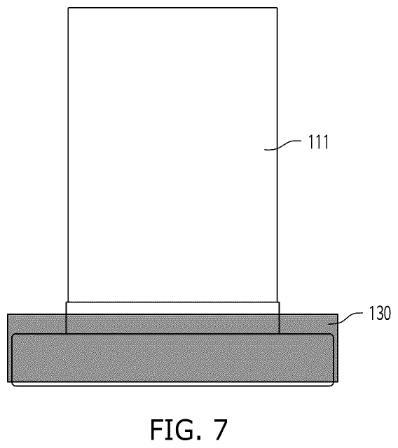

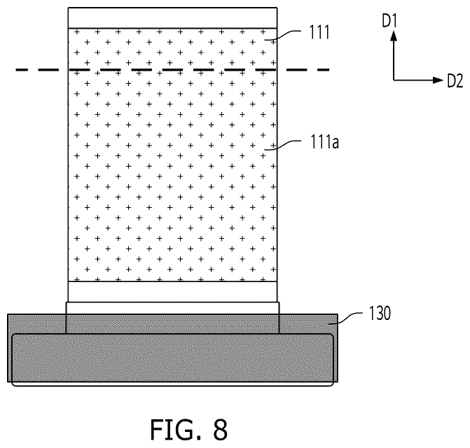

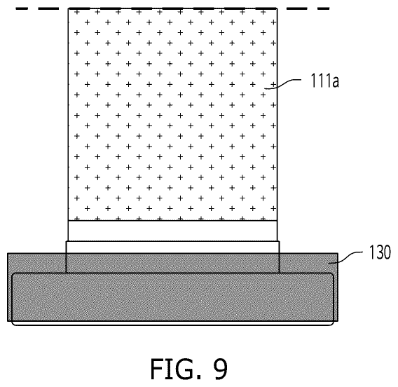

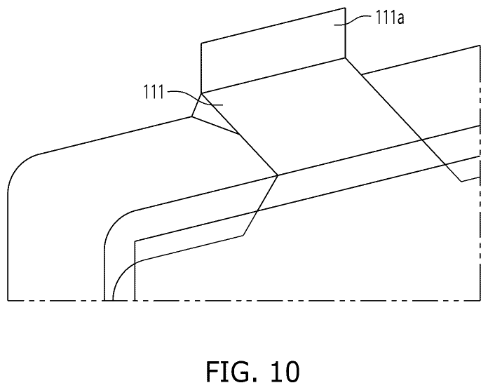

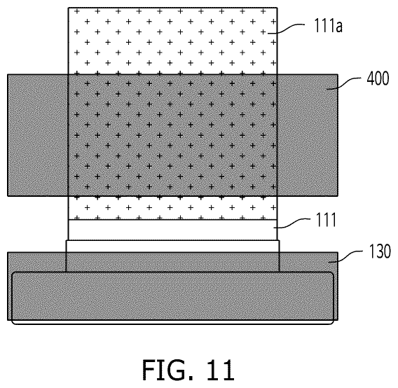

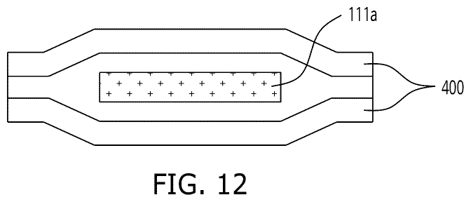

FIG. 7 is a view of a first substrate tab before welding, FIG. 8 is a view of the multi-tab formed after the plurality of first substrate tabs of FIG. 7 are welded, FIG. 9 is a view of the multi-tab in a cut state along the cutting line (dotted line) of FIG. 8, and FIG. 10 is a perspective view of the multi-tab of FIG. 9. FIG. 11 is a view of a first sealing member attached to the cut multi-tab of FIG. 9, and FIG. 12 is a cross-sectional view of the first sealing member attached to the multi-tab of FIG. 11.

FIGS. 7 through 12 illustrate an embodiment of a process in which the first multi-tab 111a is formed. The first multi-tab 111a may be formed by coupling the plurality of first substrate tabs 111 by welding. Referring to FIG. 7, the plurality of first substrate tabs 111 may be disposed on one surface of the first electrode in the first direction D1. In this state, the first substrate tabs 111 may be ultrasonically welded together to form the first multi-tab 111a.

In an embodiment, referring to FIG. 8, the first multi-tab 111a may be formed by welding the first substrate tabs 111 from a first end to a second end in the second direction D2. After welding the plurality of first substrate tabs 111 to form the first multi-tab 111a, rigidity of the first multi-tab 111a in the second direction D2 may be maintained.

The first multi-tab 111a may be formed by welding in a section that is closer to a first end of the first substrate tabs 111 in the first direction D1 than to the separator 130. Here, a first end of the plurality of first substrate tabs 111 may refer to the end that is farther from the separator 130. The second end of the plurality of first substrate tabs 111 may refer to the end adjacent to the separator 130.

The first substrate tabs 111 may be welded in only a partial region in the first direction D1. For example, one end of the plurality of first substrate tabs 111 may be welded in only a partial region in consideration of the portion to be removed by cutting. The other end of the plurality of first substrate tabs 111 may be welded in consideration of the angle required for bending and coupling in the first direction D1.

By pre-welding the first substrate tabs 111 to form the first multi-tab 111a, the first substrate tabs 111 may be effectively secured and uniformity of the cut surface may be improved. Thus, performance and durability of the first multi-tab 111a may be improved, an in turn, performance and durability of the secondary battery may be improved. Also, by pre-welding the first substrate tabs 111 to form the first multi-tab 111a, the first substrate tabs 111 may be cut without using a separate guide that gathers and fixes the plurality of first substrate tabs 111. Thus, as compared to cutting with a separate guide, the first multi-tab 111a may be cut to a shorter length in the first direction D1. FIG. 9 shows an example of the cut first multi-tab 111a.

In an embodiment, a portion of the first multi-tab 111a exposed outside of the case may be welded over an entire surface of the first multi-tab 111a. When cutting the first multi-tab 111a, the fully welded portion may be cut with consideration of the strength of the portion of the first multi-tab 111a that is exposed.

Referring to FIGS. 11 and 12, after cutting the first multi-tab 111a, a first sealing member 400 may be attached to surfaces of the first multi-tab 111a. The portion of the first sealing member 400 in contact with the first multi-tab 111a may exhibit adhesive properties, and the outer surface may be formed of a material having thermal insulation and/or insulating properties. The first sealing member 400 may have a width in the second direction D2 that is greater than the width of the first multi-tab 111a in the second direction D2. As such, when the electrode assembly is received in the case and covered, the first multi-tab 111a may be insulated from the case and the cover.

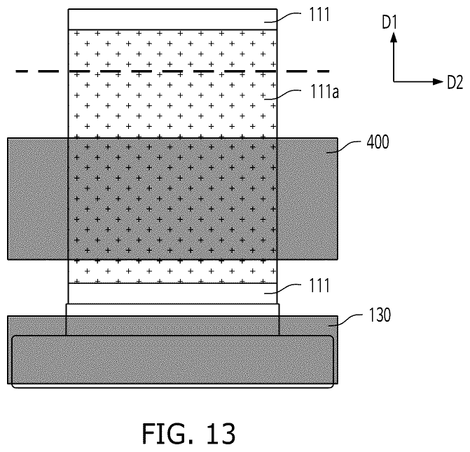

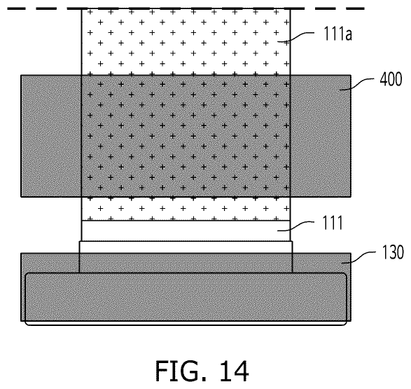

FIG. 13 is a view of a multi-tab according to another embodiment of the present disclosure, and FIG. 14 is a view of the FIG. 13 after being cut.

FIGS. 13 and 14 illustrate another embodiment of a process in which the first multi-tab 111a is formed. In this embodiment, before cutting an end of the first multi-tab 111a, the first sealing member 400 may be attached to surfaces of the first multi-tab 111a. For example, before cutting the first multi-tab 111 a, the first sealing member 400 may be attached to surfaces of the first multi-tab 111a.

The first multi-tab 111a may be formed by welding the first substrate tabs 111 together. The first multi-tab 111a may be formed by welding the plurality of first substrate tabs 111 from a first end to a second end in the second direction D2. After welding the first substrate tabs 111 to form the first multi-tab 111a, rigidity of the first multi-tab 111a in the second direction D2 may be maintained.

The first multi-tab 111a may be formed by welding in a section that is closer to a first end of the first substrate tables 111 in the first direction d1 than to the separator 130. The first substrate tabs 111 may be welded in only a partial region in the first direction D1. For example, ends of first substrate tabs 111 may be welded in only a partial region in consideration of the portion that will be cut off, and the other end of the plurality of first substrate tabs 111 may be welded in consideration of the angle required for bending and coupling in the first direction D1.

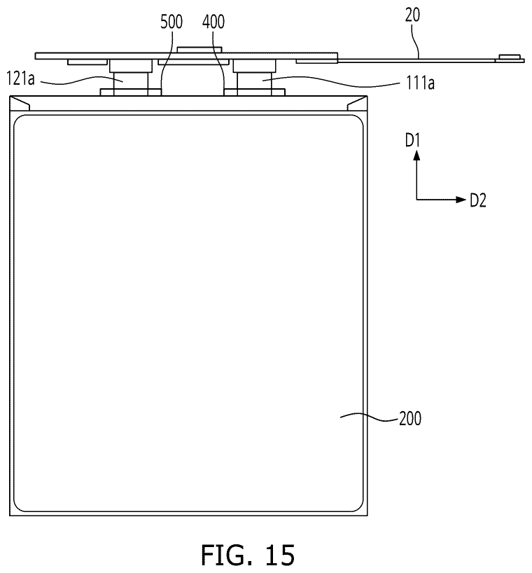

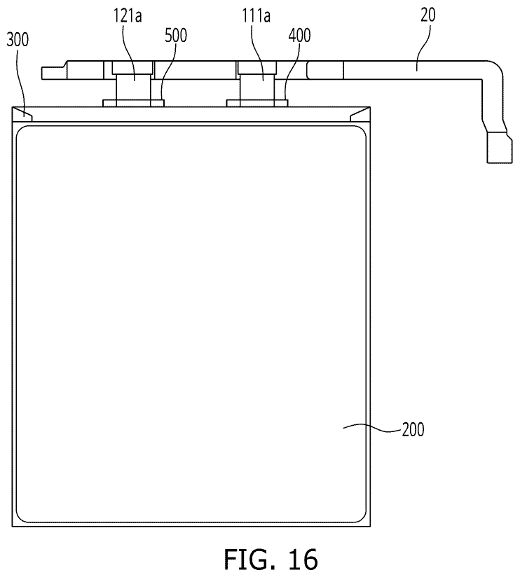

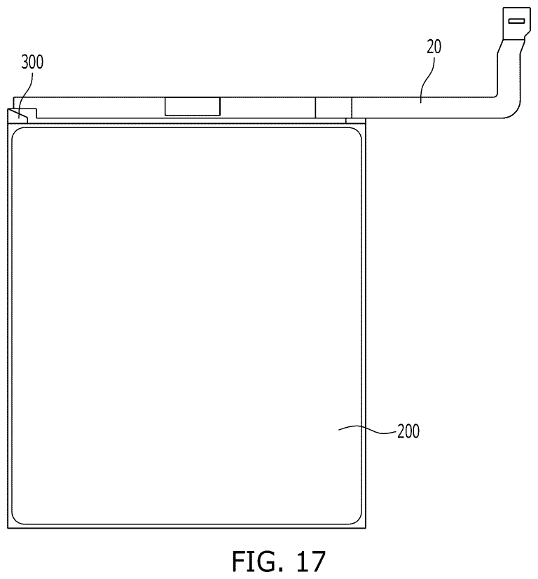

FIG. 15 is a view of a protection circuit module attached to a secondary battery according to an embodiment of the present disclosure, FIG. 16 is a view of the protection circuit module of FIG. 15 bent 90 degrees rearward, and FIG. 17 is a view of the protection circuit module of FIG. 16 bent 180 degrees forward.

Referring to FIGS. 15 through 17, a protection circuit module 20 may be coupled to the first multi-tab 111a and the second multi-tab 121a that are exposed outside of the case 200. In this embodiment, the first sealing member 400 may be adhered to surfaces of the first multi-tab 111a, and the second sealing member 500 may be adhered to surfaces of the second multi-tab 121a.

The protection circuit module (PCM) 20 is electrically connected to the secondary battery and may prevent overheating and an explosion caused by overcharging, overdischarging, or overcurrent. The protection circuit module 20 may include a safety element, such as a passive element (e.g., a resistor or capacitor) or an active element (e.g., a field transistor), or a protective circuit element that may be formed with integrated circuits.

The protection circuit module 20 may be disposed on the upper surface of the case 200. The protection circuit module 20 may include a flexible printed circuit board. The protection circuit module 20 also may include a connector on one surface of an extraction portion that extends to one side to connect to an external device. The protection circuit module 20 may be connected to the external device through the connector. The protection circuit module 20 may deliver electrical energy stored in the secondary battery to the external device or may receive a control signal for controlling operation of the secondary battery from the external device.

As shown in FIG. 15, the protection circuit module 20 may be coupled to the first multi-tab 111a and the second multi-tab 121a that are exposed outside of the case 200. In this arrangement, the protection circuit module 20 may be bent 90 degrees rearward as shown in FIG. 16. Thereafter, the protection circuit module 20 may be rotated and bent 180 degrees forward as shown in FIG. 17.

Using the process steps as described herein, the protection circuit module 20 may be provided to the secondary battery to manufacture a battery pack, with the protection circuit module 20 being connected to the secondary battery by being bent and seated in the correct position at the upper portion of the secondary battery.

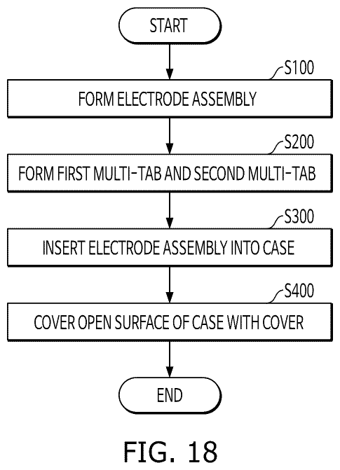

FIG. 18 is a flowchart of a method of manufacturing a secondary battery according to an embodiment of the present disclosure.

In an embodiment, the method of manufacturing a secondary battery may include an electrode assembly formation step S100, a first multi-tab formation and a second multi-tab formation step S200, a step S300 of inserting the electrode assembly into a case, and a step S400 of covering and sealing the case with a cover.

The electrode assembly formation step S100 may include forming a first electrode having a plurality of first substrate tabs extending in the first direction, a second electrode spaced apart from the first electrode in a second direction that is perpendicular to the first direction and has a plurality of second substrate tabs extending in the first direction, and a separator disposed between the first electrode and the second electrode.

The first multi-tab formation and the second multi-tab formation step S200 may include a step of coupling the first substrate tabs to each other to form a first multi-tab, and a step of coupling second substrate tabs to each other to form a second multi-tab.

The step S200 of forming the first multi-tab may include cutting off a portion of the first multi-tab and attaching a first sealing member to surfaces of the cut first multi-tab.

According to another embodiment, the step S200 of forming the first multi-tab may include attaching a first sealing member to surfaces of the first multi-tab and, after attaching the first sealing member, cutting off a portion of the first multi-tab.

In covering at least a portion of the electrode assembly, the first sealing member may be attached to surfaces of the first multi-tab so as to contact with the case and the cover. Thus, the case and the cover may be sealed with the first sealing member interposed therebetween. When the first sealing member is disposed between the case and the cover, the case and the cover may be sealed by applying pressure using a heating jig. The first sealing member may insulate the first multi-tab from the case and the cover. A portion of the first sealing member may be exposed to outside of the case and the cover in the first direction.

In step S200, the first multi-tab may be formed by ultrasonically welding the first substrate tabs and the second multi-tab may be formed by ultrasonically welding the second substrate tabs.

In particular, in the step S200 the first substrate tabs may be welded from a first end of the first substrate tabs in the second direction to a second end of the first substrate tabs in the second direction to form the first multi-tab. The first multi-tab may be formed by welding the first substrate tabs in a section that is closer to a first end of the first substrate tabs in the first direction than to the separator. A portion of the first multi-tab that is exposed outside of the case may be welded over an entire surface of the first multi-tab. Among the first substrate tabs, a specific first substrate tab may not be bent (may be in an unbent state) and may extend in the first direction.

In step S300 of inserting the electrode assembly into the case, the electrode assembly is insert through an opening in the case. Thereafter, the step S400 of covering and sealing the case with a cover may be performed. In step S400, at least a portion of the electrode assembly may be sealed from outside of the case and cover by covering the opening in the case with the cover. The electrode assembly, case, and cover may be arranged such that at least a portion of the first multi-tab and a portion of the second multi-tab are exposed outside of the case and cover.

It should be noted that the steps shown in flowchart depicted in FIG. 18 are merely exemplary and steps may be implemented differently in other embodiments of the present disclosure. For example, one or more steps may be omitted, the order of the steps may be changed, one or more steps may overlap or be performed repeatedly, and so on.

Although the present disclosure has been described with reference to embodiments and drawings illustrating aspects thereof, the present disclosure is not limited thereto. Various modifications and variations can be made by a person skilled in the art to which the present disclosure belongs within the scope of the technical spirit of the present disclosure.

What is claimed is:

1. A secondary battery comprising:
an electrode assembly comprising a first electrode including a plurality of first substrate tabs extending in a first direction, a second electrode spaced apart from the first electrode in a second direction that is perpendicular to the first direction and including a plurality of second substrate tabs extending in the first direction, and a separator disposed between the first electrode and the second electrode;
a case in which the electrode assembly is accommodated; and
a cover coupled to the case and sealing a portion of the electrode assembly from outside of the case and the cover,
wherein the first substrate tabs are coupled to each other to form a first multi-tab,
wherein a portion of the first multi-tab is exposed outside of the case and the cover, and
wherein the second substrate tabs are coupled to each other to form a second multi-tab, and
wherein a portion of the second multi-tab is exposed outside of the case and the cover.

2. The secondary battery as claimed in claim 1, further comprising:
a first sealing member attached to surfaces of the first multi-tab; and
a second sealing member attached to surfaces of the second multi-tab.

3. The secondary battery as claimed in claim 2, wherein the first sealing member is in contact with the case and the cover,
wherein the case and the cover are sealed with the first sealing member interposed between the case and the cover, and
wherein the first sealing member insulates the first multi-tab from the case and the cover.

4. The secondary battery as claimed in claim 2, wherein a portion of the first sealing member extends in the first direction and is exposed outside of the case and the cover.

5. The secondary battery as claimed in claim 1, wherein the first multi-tab is formed by ultrasonically welding the first substrate tabs together, and
wherein the second multi-tab is formed by ultrasonically welding the second substrate tabs together.

6. The secondary battery as claimed in claim 1, wherein the first multi-tab is formed by welding the first substrate tabs from first ends of the substrate tabs in the second direction to second ends of the first multi-tabs in the second direction.

7. The secondary battery as claimed in claim 1, wherein the first multi-tab is formed by welding the first substrate tabs in a section that is closer to an end of the first substrate tabs in the first direction than to the separator.

8. The secondary battery as claimed in claim 1, wherein the portion of the first multi-tab that is exposed outside of the case is welding along a surface of the first multi-tab from a first end of the first multi-tab to a second end of the first multi-tab.

9. The secondary battery as claimed in claim 1, wherein among the first substrate tabs, one of the substrate tabs is not bent and extends in the first direction.

10. A method of manufacturing a secondary battery, the method comprising:
forming an electrode assembly comprising (i) a first electrode including a plurality of first substrate tabs extending in a first direction, (ii) a second electrode spaced apart from the first electrode in a second direction that is perpendicular to the first direction and including a plurality of second substrate tabs extending in the first direction, and (iii) a separator disposed between the first electrode and the second electrode;
forming a first multi-tab by coupling the first substrate tabs
forming a second multi-tab by coupling the second substrate tabs;
inserting the electrode assembly into the case comprising an opening such that a portion of the first multi-tab and a portion of the second multi-tab are exposed outside of the case; and
covering the opening in the case with a cover to seal a portion of the electrode assembly from outside of the case and cover.

11. The method of manufacturing a secondary battery as claimed in claim 10, wherein forming the first multi-tab comprises:
cutting a portion of the first multi-tab; and
attaching a sealing member to surfaces of the cut first multi-tab.

12. The method of manufacturing a secondary battery as claimed in claim 10, wherein forming the first multi-tab comprises:
attaching a sealing member to surfaces of the first multi-tab; and
after attaching the sealing member, cutting off a portion of the first multi-tab.

13. The method of manufacturing a secondary battery as claimed in claim 11, wherein covering the opening in the case with the cover includes attaching the sealing member to surfaces of the first multi-tab such that the sealing member contacts the case and the cover.

14. The method of manufacturing a secondary battery as claimed in claim 11, wherein the case and the cover are sealed with the sealing member interposed therebetween, and
wherein the sealing member insulates the first multi-tab from the case and the cover.

15. The method of manufacturing a secondary battery as claimed in claim 11, wherein a portion of the sealing member is exposed outside of the case and the cover in the first direction.

16. The method of manufacturing a secondary battery as claimed in claim 10, wherein forming the first multi-tab includes ultrasonically welding the first substrate tabs, and
wherein forming the second multi-tab includes ultrasonically welding the second substrate tabs.

17. The method of manufacturing a secondary battery as claimed in claim 10, wherein forming the first multi-tab includes welding the first substrate tabs from a first ends of the first substrate tabs in the second direction to second ends of the first substrate tabs in the second direction.

18. The method of manufacturing a secondary battery as claimed in claim 10, wherein forming the first multi-tab comprises welding the first substrate tabs in a section that is closer to an end of the first substrate tabs in the first direction than to the separator.

19. The method of manufacturing a secondary battery as claimed in claim 10, wherein the portion of the first multi-tab that is exposed to outside of the case is formed by welding a surface of the first multi-tab from a first end of the first multi-tab to a second end of the first multi-tab.

20. The method of manufacturing a secondary battery as claimed in claim 10, wherein among the plurality of first substrate tabs, a substrate tab is not bent and extends in the first direction.
